(19) United States
(12) Patent Application Publication
(10) Pub. No.: US 2018/0339586 A1
(43) Pub. Date: Nov. 29, 2018

(54) PLANETARY-STAGE AUTOMATIC TRANSMISSION HAVING AN ALTERNATIVE AUXILIARY POWER TAKE-OFF ASSEMBLY

(71) Applicant: ZF Friedrichshafen AG, Friedrichshafen (DE)

(72) Inventor: Michael TRÜBENBACH, Friedrichshafen (DE)

(21) Appl. No.: 15/777,988

(22) PCT Filed: Nov. 11, 2016
(86) PCT No.: PCT/EP2016/077466

§ 371 Date: May 22, 2018

(30) Foreign Application Priority Data
Nov. 27, 2015 (DE) 10 2015 223 604.8

(51) Int. Cl. B60K 17/28; F16H 45/02; F16H 47/08; F16H 3/66

(52) U.S. Cl. CPC B60K 17/28; F16H 45/02; F16H 2200/2043; F16H 3/66; F16H 2200/2012; F16H 47/08

(57) ABSTRACT

A planetary-stage automatic transmission with a transmission housing which has a first region in which a transmission input shaft is positioned, a transmission output shaft and a plurality of planetary-stages for the creation of different gear ratios. A hydrodynamic startup has a turbine wheel and connects an engine to the transmission input shaft of the planetary-stage automatic transmission. A power take-off assembly comprises a drive wheel and is positioned in a second region in the transmission housing, between the hydrodynamic startup and the first region which accommodates the planetary-stages. The turbine wheel is connected with the drive wheel of the power take-off assembly. A rotational speed sensor is positioned in the second region of the transmission housing for detecting the rotational speed of the transmission input shaft.

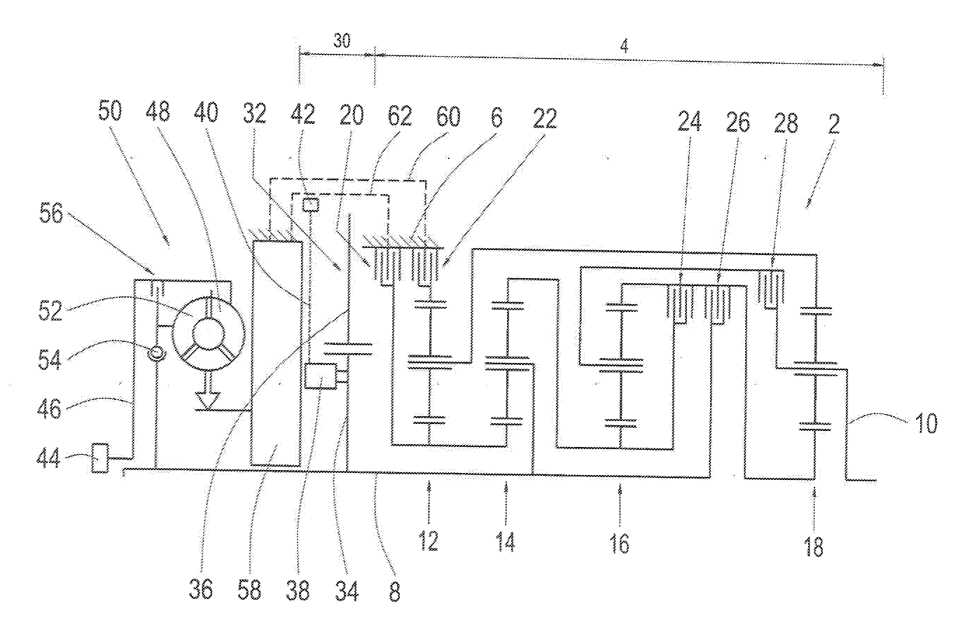

This application is a National Stage completion of PCT/EP2016/077466 filed Nov. 11, 2016, which claims priority from German patent application serial no. 10 2015 223 604.8 filed Nov. 27, 2015.

### FIELD OF THE INVENTION

This invention relates to a planetary-stage automatic transmission with an alternative auxiliary power take-off assembly.

### BACKGROUND OF THE INVENTION

Known from DE 26 56 669 C2 is a planetary-stage automatic transmission which has an auxiliary take-off assembly positioned at the transmission input side, which is arranged spatially and in axial sequence between a torque converter and the transmission input shaft. The torque converter connects an engine, via its turbine wheel, to the transmission input shaft, while the engine is connected, via the pump wheel of the torque converter, directly to the drive gear of the gear chain of the power take-off without a damping device. Between the engine and the transmission input shaft, dampening of vibrations and other loads from the engine is carried out hydraulically by the oil of the torque converter, while the vibrations and other loads are unabatedly transferred to the power take-off and the components following the power take-off. As a result, there are increased demands on the component strength and noise prevention, especially in the gear chain of the power take-off.

Known from EP 1 838 977 B2 are other versions of an additional planetary-stage automatic transmission, where at least one version has shift elements at the transmission input side which when required, establish a connection between the rotating parts of the automatic transmission and the transmission housing. The shift elements are responsible to create a connection between the pistons which are filled with a hydraulic liquid to create pressure. The transfer of the hydraulic liquid to the pistons usually happens via boreholes and openings in the transmission housing. The nested arrangement of the planetary-stages and shafts in the transmission causes, when assembly space is limited, problems with the positioning of a rotational speed sensor which monitors the rotational speed of the transmission input shaft.

### SUMMARY OF THE INVENTION

Based on the above-mentioned prior art, the object of the present invention is to provide a planetary-stage automatic transmission with an auxiliary take-off assembly which eliminates the existing shortcomings.

The object is achieved by an alternative power take-off assembly in a planetary-stage automatic transmission with the characteristics of claim 1.

According to the invention, a planetary-stage automatic transmission has a transmission housing where a first region is designed to accommodate a transmission input shaft, a transmission output shaft, and a plurality of planetary-stages to create different gear ratios. The planetary-stage automatic transmission has also a hydrodynamic startup element which includes a turbine wheel and connects a drive engine for the planetary-stage automatic transmission with the transmission input shaft. The planetary-stage automatic transmission has also a power take-off assembly, which includes a drive gear, that is positioned in the second region of the transmission housing, between the hydrodynamic startup element and the first region which has the planetary-stages. In accordance with the invention, the turbine wheel of the hydrodynamic startup element is directly or indirectly connected with the drive wheel of the power take-off assembly. This results in a decoupling of the power take-off assembly from the motor vibrations of the engine by a hydrodynamic torque transfer, or the torsion damper, respectively, to a drive wheel, instead of a solid and direct connection which would be created if the pump wheel of the hydrodynamic startup element is directly connected with the drive wheel of the power take-off assembly. In the second region of the transmission housing, which accommodates the power take-off assembly, a rotational speed sensor is arranged to capture the rotational speed of the transmission input shaft. At this time, the sufficient and large axial construction space, which is created through the power take-off assembly, a rotational speed sensor can be accommodated and the rotational speed of the transmission input shaft, which is now available through the connection of the drive wheel of the power take-off configuration and the transmission input shaft, can be directly measured. It takes place outside of the first region in the transmission housing which has the plurality of gear ratios steps and where, through experience, the space is very tight because of the nesting arrangement of the gear ratios steps. The axial space of the second region of the power take-off assembly is sufficient to position a known, reliable, yet cost-effective rotational speed sensor.

In the first region of the transmission housing, shift elements are provided which can be actuated by opening or closing, to shift the individual planetary-stages into the different gear ratios. The shift elements are usually actuated hydraulically when hydraulic liquid under pressure is directed into the shift element, so as to close the shift dement, and when the pressure of the hydraulic liquid is reduced, or the hydraulic liquid is emptied by the shift element, respectively, so as to open the shift element. In a preferred embodiment of the invention, the hydraulic connection is located, for the shift dements for the shifting the different gear ratios which are located in the first region, outside of the first region of the transmission housing in which the planetary-stages are provided, and is located instead between the hydrodynamic startup dement and the first region of the transmission housing. This ensures that the shift dements remain spatially close to the planetary-stages. Hereby, the hydraulic connection is spatially detached and is placed as an independent part between the hydrodynamic startup element and the first region of the transmission housing, which also contains the shift dements. Especially advantageous is the positioning of the hydraulic connection outside of the first region in a way that it is provided between the hydrodynamic startup element and the second region which accommodates the power take-off assembly. Thus, the axial construction space can be advantageously used, due to the hydraulic connection and the power take-off assembly, so as to include the rotational speed sensor.

The term hydraulic connection ase used herein means the distribution of the hydraulic liquid and the supply of hydraulic liquid to at least one shift element, in particular oil, so as to activate the shift element. The hydraulic liquid is transferred through a hydraulic control unit through the hydraulic connection for at least one of the shift elements. In the case, in which the hydraulic liquid is hereby guided over the rotating transmission shaft, it must be ensured that the hydraulic liquid can be transferred without loss from the rotating part to the fixed part and vice versa.

These shift elements which are provided in the first region of the transmission housing are preferably multi-disc brakes and clutches which can at least decelerate one of the rotating transmission parts in the first region against the transmission housing and can at least couple or decouple one transmission part to the transmission housing. Through the provision of the multi-disc brakes being fixed at the transmission housing, the supply of hydraulic liquid can be brought form into the piston area of the shift element through the transmission housing so that the connection between the hydraulic connection and the shift element is established in the transmission housing.

An advantageous embodiment shows a torque converter as the hydrodynamic startup element. Hereby, a smooth start-up and a provided torque increase through eventually the torque converter can be used during the start up.

An additional, advantageous embodiment has for the further decoupling of the transmission input shaft from the vibrations and additional influences at the engine a torsion damper, through which the turbine wheel of the hydrodynamic startup element is connected with the power take-off assembly. The torsion damper can also be positioned in a way, when an intermediate clutch which bridges one of the hydrodynamic startup elements is provided, that it can create a reduction damping effect.

### BRIEF DESCRIPTION OF THE DRAWING

The invention is further explained based on the sole drawing which shows a schematic view of a planetary-stage automatic transmission according to the invention.

### DETAILED DESCRIPTION OF THE PREFERRED EMBODIMENTS

The Figure shows the planetary-stage automatic transmission 2. Positioned in a first region 4 of a transmission housing 6 are a transmission input shaft 8, a transmission output shaft 10, and a plurality of planetary-stages 12, 14, 16, 18. Shift elements 20, 22, 24, 26, and 28 serve in a known manner for the implementing different gear ratios by changing connections of elements of the planetary-stages 12, 14, 16, and 18 with each other or with the transmission housing 6.

In a second region 30 of the transmission housing 6, a power take-off assembly 32 is provided, which has a drive wheel 34 that is in operational connection with the transmission input shaft 8. The drive wheel 34 can interact with an additional gear wheel 36 of the power take-off assembly 32, which cooperates in a manner, not described here, with additional components of the power take-off assembly 32 in a known manner.

A rotational speed sensor 38 is provided in the second region 30 which registers the rotational speed of the drive wheel 34 of the power take-off assembly 32 that is connected with the transmission input shaft 8. The rotational speed sensor 38 is connected with the control device 42 through a control lead 40.

An engine 44 of a vehicle, not shown here, drives the pump wheel 48 of a hydrodynamic startup element 50 designed as a torque converter via a motor shaft 40. The turbine wheel 52 of the hydrodynamic startup element 50 is connected in a rotationally fixed manner with the input shaft 8 and the drive wheel 34 of the power take-off assembly 32 via a torsion damper 54. With the aid of a lock-up clutch 56, a rotationally fixed connection can be established between the pump wheel 48 and the turbine wheel 52 and thus, the hydrodynamic startup element 50 can be short-circuited.

Between the hydrodynamic startup element 50 and the second region 30 of the transmission housing 6, a hydraulic connection 58 is provided at least for the shift elements 20 and 22, which are connected via connecting lines 60 and 62 that extend for example in the transmission housing 6 and are connected with the shift elements 20 and 22. For further shift elements 24, 26, for example, a hydraulic connection, which is not shown, takes place in a known art from the hydraulic connection 58 via the transmission input shaft 8.

Thus, a spatial separation is created for shift elements and the hydraulic connection and in the axial space in the region 30 of the transmission housing 6 which accommodates the power take-off assembly 32, a rotational speed tap is created to measure the transmission input shaft rotational speed.

### REFERENCE CHARACTERS

2 Planetary-Stage Automatic Transmission
4 First region
6 Transmission housing
8 Transmission Input Shaft
10 Transmission Output Shaft
12 Planetary-Stage
14 Planetary-Stage
16 Planetary-Stage
18 Planetary-Stage
20 Shift Element
22 Shift Element
24 Shift Element
26 Shift Element
28 Shift Element
30 Second region
32 Power take-off assembly
34 Drive Wheel
36 Gear
38 Rotational Speed Sensor
40 Control Connection Line
42 Control System
44 Engine
46 Motor Shaft
48 Pump Wheel
50 Starting Element
52 Turbine Wheel
54 Torque Damper
56 Lock-up clutch
58 Hydraulic Connection
60 Connection Line
62 Connection Line

1-6. (canceled)

7. A planetary-stage automatic transmission (2) comprising:
a transmission housing (6) having a first region (4) in which a transmission input shaft (8), a transmission output shaft (10), and a plurality of planetary-stages (12, 14, 16, 18) being positioned to create different gear ratios,
a hydrodynamic startup element (50), including a turbine wheel (52), connecting an engine (44) with the transmission input shaft (8) of the planetary-stage automatic transmission (2),
a power take-off assembly (32) having a drive wheel (34) and being positioned in a second region (30) in the transmission housing (6), between the hydrodynamic startup element (50) and the planetary-stages (12, 14, 16, 18) of the first region (4),
the turbine wheel (52) being connected with the drive wheel (34) of the power take-off assembly (32), and
a rotational speed sensor (38) being positioned in the second region (30) of the transmission housing (6) for detecting a rotational speed of the transmission input shaft (8).

8. The planetary-stage automatic transmission (2) according to claim 7, wherein a hydraulic connection (58) of shift elements (20, 22), which are provided in the first region (4) of the transmission housing (6) to shift different gear ratios, is provided outside of the first region (4) between the hydrodynamic startup element (50) and the first region (4),

9. The planetary-stage automatic transmission (2) according to claim 8, wherein the hydraulic connection (58) is provided outside of the first region (4) of the transmission housing (6) between the hydrodynamic startup element (50) and the second region (30) of the transmission housing (6).

10. The planetary-stage automatic transmission (2) according to claim 8, wherein the shift elements (20, 22) are multi-disc brakes, which brake at least one rotating transmission component in the first region (4) against the transmission housing (6), and either couple or decouple at least one transmission component with the transmission housing (6).

11. The planetary-stage automatic transmission (2) according to claim wherein the hydrodynamic startup element (50) is a torque converter.

12. The planetary-stage automatic transmission (2) according to claim 7, wherein the turbine wheel (52) of the hydrodynamic startup element (50) is connected, via a torsion damper (54), with the drive gear (34) of the power take-off assembly (32).

13. A planetary-stage automatic transmission comprising:
a transmission housing having first and second axial regions;
a transmission input shaft, a transmission output shaft, and a plurality of planetary-stages being positioned in the first axial region of the transmission housing and forming different gear ratios of the automatic transmission;
a hydrodynamic startup element including a turbine wheel and being connected, via the transmission input shaft of the planetary-stage automatic transmission, to an engine;
a power take-off assembly having a drive wheel and being positioned in the second region in the transmission housing, axially between the hydrodynamic startup element and the plurality planetary-stages of the first region, and the turbine wheel being connected with the drive wheel of the power take-off assembly; and
a rotational speed sensor being positioned in the second region of the transmission housing for detecting a rotational speed of the transmission input shaft.
